(19) United States
(12) Patent Application Publication
(10) Pub. No.: US 2021/0370709 A1
(43) Pub. Date: Dec. 2, 2021

(54) Silicone Paint Tray and Liner

(71) Applicant: Rebekah Charlene Alexis, East Greenbush, NY (US)

(72) Inventor: Rebekah Charlene Alexis, East Greenbush, NY (US)

(21) Appl. No.: 16/889,391

(22) Filed: Jun. 1, 2020

(51) Int. Cl. B44D 3/12

(52) U.S. Cl. CPC B44D 3/126

(57) ABSTRACT

A Silicone based paint tray or liner of which will be responsible to containing paint for household and commercial projects. The silicone paint tray and liner will be standard in size to be utilized by various painting accessories on the market. The composition of the paint tray and liner will allow more productive work as cleanup will be minimal. The silicone paint tray and liner will have a low impact on the environment.

### FIELD

Embodiments contained herein relate to paint trays and paint liners. More specifically, embodiments described herein relate to a paint tray and liner for capturing; and containing paint for household and commercial use.

### BACKGROUND

A paint tray responsible for containing paint to use via a paint roller or brush to disperse paint evenly over said painting instrument. Paint trays are typically made of sheet metals, or polymers of various types and percentages. Paint trays are utilized in such a way that it can be reused to accomplish multiple tasks.

A paint tray liner is responsible for the same functions as the above-mentioned paint tray. The exception is its utilization; a paint tray liner is designed to be lighter and not as durable as a paint tray in its structure to advance the lifetime of a paint tray. The paint tray liners' purpose is to fit inside a paint tray to prevent the depreciation of a paint tray, paint tray liners are typically composed of various percentages of polymers. All paint tray liners are intended for temporary use.

### DESCRIPTION

The paint tray and liner are made completely of silicone, which will allow private and commercial consumers to have a more durable product for painting tasks. The silicone paint tray and liner will leave a low waste footprint on the environment as it will be recyclable and will prevent excess paint from being captured in drains and spillways. This is attained by allowing the paint to dry in the trays and peeling it off because the paint will not stick to the silicone trays. The silicone tray or liner will be resistant to extreme temperatures, will not rust, and will not be subject to landfills due to its recyclability.

A paint tray used to hold paint for changing the color or appearance of a household or commercial project with a paint roller or brush utilizing paint of various compositions. As depicted in FIG. 1 of the drawings, the paint tray is completely comprised of silicone. Its dimensions are that of a standard paint tray to house various sizes of paint brushes and paint rollers. The paint tray's rectangular shape and open top allows paint to be poured and contained within its structure.

The paint tray as referenced in FIG. 1 of the drawings will have standard ridges or texture in its base to contribute to the even spread of paint in its housing compartment. The Silicone composition of the paint tray allows for a mess free clean up by allowing the paint to dry and simply peel off. The silicone paint tray can be bent or flexed and naturally return to its original form, this action allows for a more durable and sustainable paint tray. The paint trays silicone composition will significantly reduce the impact on the environment.

A paint tray liner that can be inserted into any paint tray for the ease of clean up on any painting project. As seen in drawing FIG. 2 of this application the paint tray liner is standard in its dimensions to allow it to be utilized in any household or commercial painting task. The paint tray liner will be completely comprised of silicone which would allow ease of clean up after a painting job.

The paint tray liner contains a slightly textured surface within its rectangular shape and slope to allow paint to be evenly spread throughout its structure. The drawing in FIG. 2 of the application depicts the paint tray liners simple construction and due to its silicone composition; it will be far more durable and reusable.

### BRIEF DESCRIPTION OF DRAWINGS

FIG. 1 is a perspective view of a paint tray.

FIG. 1 (1) visually depicts the left side wall of the paint tray.

FIG. 1 (2) visually depicts the back wall of the paint tray.

FIG. 1 (3) visually depicts the right-side wall of the paint tray.

FIG. 1 (4) visually depicts the front wall of the paint tray.

FIG. 1 (5) visually depicts the top side base of the paint tray.

FIG. 2 is a perspective view of a paint tray liner.

FIG. 2 (1) visually depicts the left side wall of the paint tray liner.

FIG. 2 (2) visually depicts the back wall of the paint tray liner.

FIG. 2 (3) visually depicts the right-side wall of the paint tray liner.

FIG. 2 (4) visually depicts the front wall of the paint tray liner.

FIG. 2 (5) visually depicts view of the top side base of the paint tray.

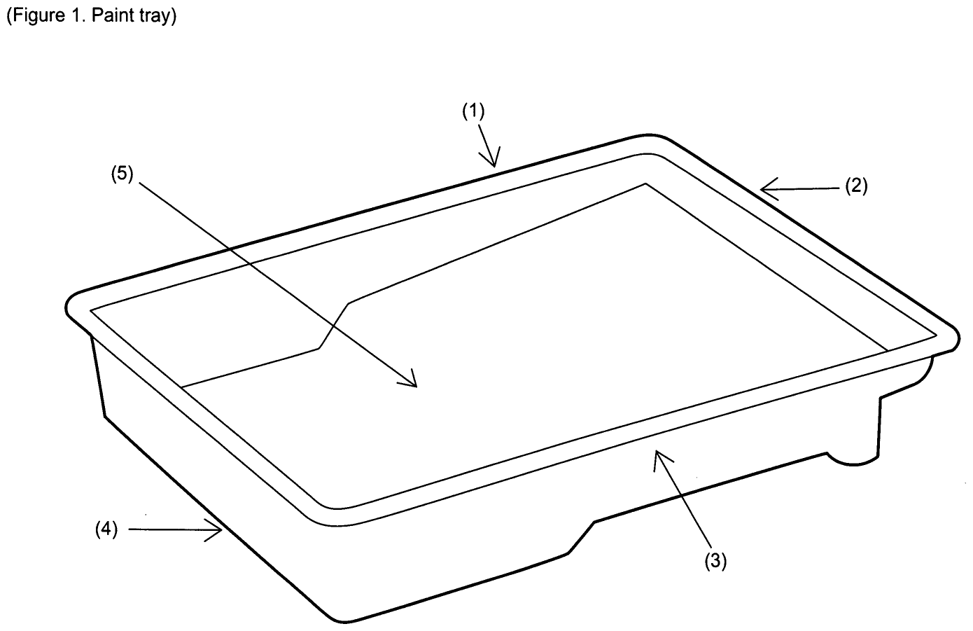

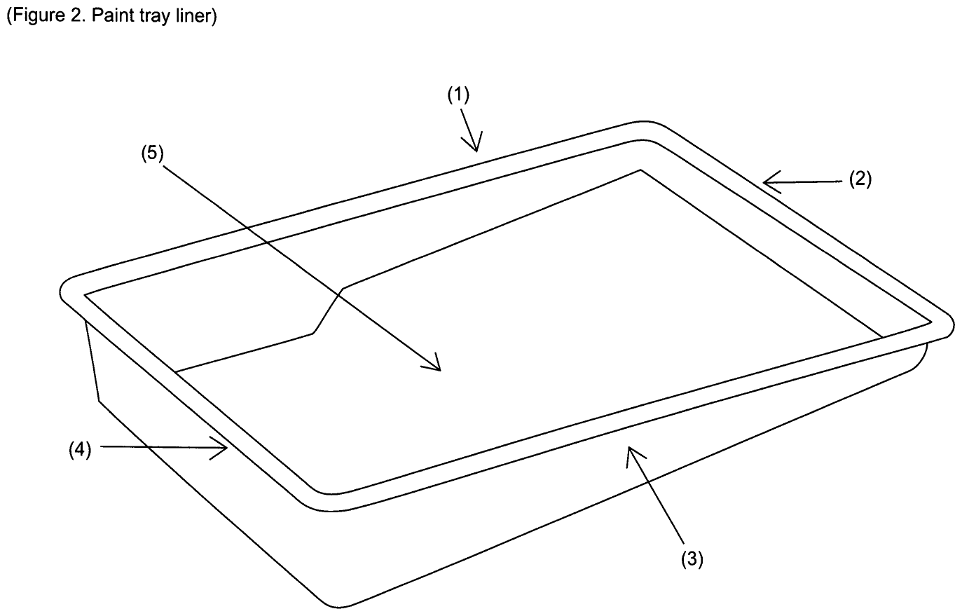

1: The paint tray completely made/composed/created of silicone.

2: The paint tray of claim 1, wherein it is yellow.

3: The paint tray of claim 1, wherein it is blue.

4: The paint tray of claim 1, wherein it is white.

5: The paint tray of claim 1, wherein it is black.

6: The paint tray of claim 1, wherein it is orange.

7: The paint tray of claim 1, wherein it is clear.

8: The paint tray of claim 1, wherein it is multi-colored.

10: The paint tray liner completely made/composed/created of silicone.

11: The paint tray liner of claim 2, wherein the paint tray liner can fit in any paint tray.

12: The paint tray liner of claim 2, wherein it is yellow.

13: The paint tray liner of claim 2, wherein it is blue.

14: The paint tray liner of claim 2, wherein it is white.

15: The paint tray liner of claim 2, wherein it is black.

16: The paint tray liner of claim 2, wherein it is orange.

17: The paint tray liner of claim 2, wherein it is clear.

18: The paint tray liner of claim 2, wherein it is multi-colored.
